(19) United States
(12) Patent Application Publication
(10) Pub. No.: US 2008/0205568 A1
(43) Pub. Date: Aug. 28, 2008

(54) DSRC COMMUNICATION CIRCUIT AND DSRC COMMUNICATION METHOD

(75) Inventor: Shigeki Oyama, Kanagawa (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/680,062

(22) Filed: Feb. 28, 2007

(51) Int. Cl. H04L 7/00

(52) U.S. Cl. 375/365

(57) ABSTRACT

A DSRC communication and DSRC communication method for preventing UW detection errors as a result of shifts in timings of received data and a UW detection window. A configuration is adopted where a frame timing generating section that receives a UW detection window timing signal of a receiving slot of the head of a frame, synchronizes frames, and counts up a first synchronization bit counter to generate a frame timing, and a UW detection window timing generating section that generates a timing signal for a UW detection window of a receiving slot of the head of the next frame using the generated frame timing as a reference, are provided, and the frame timing is maintained by taking the UW detection timing at receiving slot 100 of the head of the frame as frame synchronization timing 106, and loading and counting up a value of frame synchronization bit counter within the receiving circuit at frame synchronization timing 106.

### CROSS REFERENCE TO RELATED APPLICATIONS

The disclosure of Japanese Patent Application No. 2005-254137 filed on Sep. 1, 2005 including the specification, drawings and abstract is incorporated herein by reference in its entirety.

### BACKGROUND OF THE INVENTION

1. Field of the Invention

The present invention relates to a DSRC (Dedicated Short Range Communication) communication circuit and DSRC communication method for use in a dedicated short range communication (DSRC) wireless system.

2. Description of the Related Art

The narrow band communication system is directed to a narrow range of road-to-vehicle communication such as an electronic toll collection system (ETC) and commercial vehicle management system, and is a communication scheme capable of high-speed data communication (4 Mbps). Up until now, schemes employing optical signals and schemes employing radio wave have been developed, and a communication-possible range is typically from a few meters to several hundred meters.

In the related art, as a system for providing services utilizing the DSRC, a system where roadside equipment is provided at roadsides, service areas, or the like to provide road information and content, parking management system and settlement system for gas stations and drive-through stores have been proposed. In these systems, data is usually transmitted and received from and to an in-vehicle equipment within a range (approximately 30 meters) reached by radio wave of the roadside equipment.

With a communication circuit of a DSRC mobile station of the related art, slots are synchronized in a single bit counter at a timing of detecting unique words (hereinafter referred to as “UW”) for all receiving slots. From a count value of the slot-synchronized bit counter, timing signals for a reception processing timing of the received data, such as CRC operation and simple privacy scrambling, data storage timing, timing of unique word detection windows of the subsequent receiving slot, and timing of data transmission are generated. Further, regarding the receiving circuit, in order to support the T55 standard, the receiving circuit supports data reception where the modulation scheme is only one system of ASK (Amplitude Shift Keying), and is configured to operate in synchronization with a receiving playback clock (for example, refer to Japanese Patent Document 1: Japanese Patent Application Laid-Open No. Hei. 09-289499).

However, this kind of DSRC communication of the related art has the following problems to resolve.

With the receiving circuit of the DSRC communication of the related art, a single bit counter is used, and, by synchronizing the slots in the bit counter at a timing of detecting the UW of all receiving slots and counting up the counter, the slot timing is maintained. This maintained slot timing, that is, the reception processing timing of the received data, data storage timing and timing of UW detection windows for subsequent receiving slots, are generated from the count value of the bit counter. Further, the receiving circuit of the related art adopts a specification that supports the AIRB-STD-T55 standard which is a DSRC communication standard, the modulation scheme supports ASK data reception, and the relationship between the timings of DSRC communication frames and slots is defined in the standards.

Regarding data reception, bit slot synchronization is carried out using a UW detection timing of the receiving slots, and a timing of UW detection windows of the subsequent receiving slot is generated. However, in the received data, there are cases where shift occurs between the original timing and the actual demodulation timing as a result of the influence of fading, or the like according to the environment where communication is carried out. Namely, within DSRC communication frames, there are cases where shift occurs between the timing defined in the communication standard and the timing between slots or timing between frames and slots. When the UW detection timing of the receiving slot of the head of the frame is assumed as a frame timing, and this timing is assumed as a reference, if the position of the slot shifts with respect to the frame position, the UW detection timing at the receiving slot also shifts. The shifts in the frame timing and the slot timing are also reflected in the UW detection window by generating a timing of the UW detection window of the subsequent receiving slot from the slot timing of the shifted slot. This results in the occurrence of a situation where shifts in frame timing and slot timing accumulate as a result of carrying out UW detection of receiving slots where the timing is shifted using UW detection windows in which shifts in the frame timing and slot timing are reflected. Further, the frame timing is not influenced by accumulation of shifts of the slot timing, and therefore, when data communication for one frame is completed, and data is received at the head slot of the subsequent frame, although the relationship of shifts of the frame timings and slot timings is changed as a result of the frame being switched, a UW detection window in which shifts in the frame timing and slot timing of the previous frame are reflected, is generated. As a result, a UW detection error occurs that the timing of received data and the timing of the UW detection window do not match, and there is a problem that it becomes necessary to wait retransmission of the data or carry out processing for consecutive UW reception.

Regarding the receiving circuit configuration, the DSRC communication circuit of the related art conforms to the standard specification AIRB-STD-T75 and supports only the modulation scheme of ASK, and the receiving circuit operates in synchronization with the receiving playback clock. After this, the T75 standard of the superior standard was established, and it becomes possible to apply DSRC communication to a broader range of use than in the related art by supporting the T75 standard. However, in order to support the T75 standard, it is necessary to support communication using a plurality of modulation schemes other than ASK of the related art, such as communication using QPSK and communication using frame configurations where slots of ASK and QPSK coexist. Circuits of the related art are configured to support only one system of data reception for ASK, and therefore, it is necessary to support data reception for one or a plurality of modulation schemes.

### SUMMARY OF THE INVENTION

It is therefore an object of the present invention to provide a DSRC communication circuit and DSRC communication method capable of preventing UW detection errors resulting from shifts in timing of received data and UW detection windows.

It is a further object of the present invention to provide a DSRC communication circuit and DSRC communication method capable of supporting data reception for one or a plurality of modulation schemes using a circuit configuration taking into consideration simplicity, reduced dimension and low power consumption.

According to an aspect of the invention, a DSRC communication circuit has: a frame timing generating section that receives a unique word detection window timing signal of a receiving slot of the head of a frame, synchronizes frames, and counts up a first synchronization bit counter to generate a frame timing; and a unique word detection window timing generating section that generates a timing signal for a unique word detection window of a receiving slot of the head of the next frame using the generated frame timing as a reference.

According to an aspect of the invention, a DSRC communication circuit has: a slot timing generating section that receives unique word detection window timing signals for all receiving slots, takes the unique word detection window timings as slot timings, and counts up a second synchronization bit counter to generate a slot timing; and a unique word detection window timing generating section that generates a timing signal for a unique word detection window of a receiving slot which is other than the head of a frame using the generated slot timing as a reference.

According to an aspect of the invention, a DSRC communication circuit comprises: a unique word detection section that determines a unique word bit sequence through comparison with a bit sequence pattern of a unique word set in advance and generates a unique word detection signal; and a receiving reference clock generating section that generates a receiving reference clock different from a demodulated receiving playback clock, wherein: the unique word detection section carries out unique word detection using the receiving playback clock; and the receiving reference clock generating section generates the receiving reference clock so as to match a timing of the unique word detection.

According to an aspect of the invention, a DSRC communication method has the steps of: receiving a unique word detection window timing signal of a receiving slot of the head of a frame, synchronizing frames, and counting up a first synchronization bit counter to generate a frame timing; and generating a timing signal for a unique word detection window of a receiving slot of the head of the next frame using the generated frame timing as a reference.

According to an aspect of the invention, a DSRC communication method has the steps of: receiving unique word detection window timing signals for all receiving slots, taking the unique word detection window timings as slot timings, and counting up a second synchronization bit counter to generate a slot timing; and generating a timing signal for a unique word detection window of a receiving slot which is other than the head of the frame using the generated slot timing as a reference.

According to another aspect of the invention, a DSRC communication method has the steps of: determining a unique word bit sequence through comparison with a bit sequence pattern of a unique word set in advance and generating a unique word detection signal according to a receiving playback clock; and generating a receiving reference clock signal different from a demodulated receiving playback clock so as to match a timing of the unique word detection.

### BRIEF DESCRIPTION OF THE DRAWINGS

FIG. 1 is a timing diagram showing a relationship between received data and its shifts, frame synchronization timing of a frame synchronization bit counter, frame timing, and timing of a UW detection window for a DSRC communication circuit and DSRC communication method according to Embodiment 1 of the present invention;

FIG. 2 is a timing diagram showing a relationship between received data and its shifts, slot synchronization timing of a slot synchronization bit counter, slot timing, and timing of a UW detection window for a DSRC communication circuit and DSRC communication method according to Embodiment 2;

FIG. 3 is a block diagram showing a configuration of a DSRC communication circuit and communication method according to Embodiment 3 of the present invention; and

FIG. 4 is a block diagram showing a configuration of a DSRC communication circuit and communication method according to Embodiment 4 of the present invention.

### DETAILED DESCRIPTION OF THE PREFERRED EMBODIMENTS

Embodiments of the present invention will be described in detail below with reference to the accompanying drawings.

### Embodiment 1

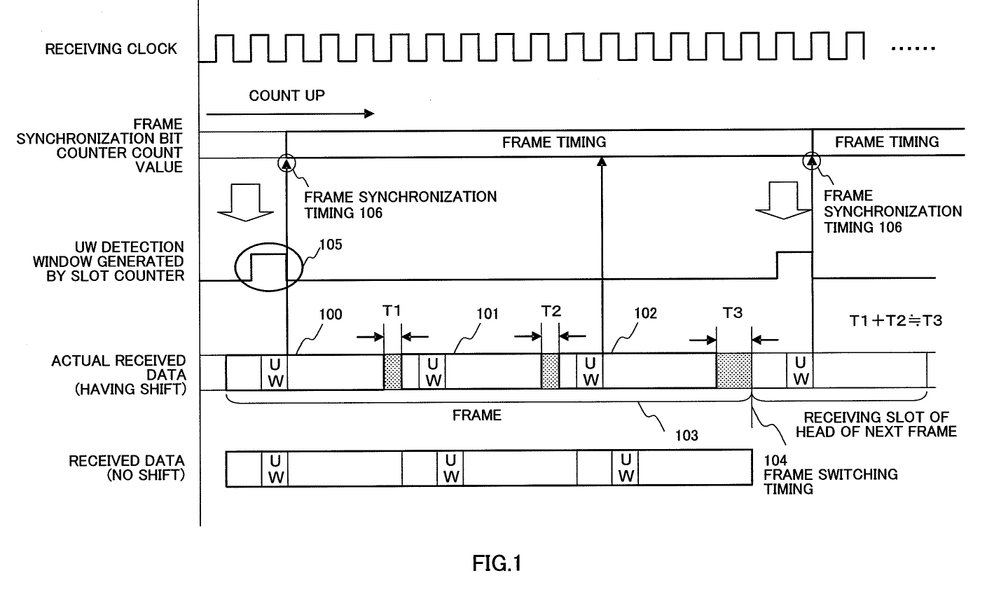

FIG. 1 is a timing diagram showing the relationship between received data and its shifts, frame synchronization timing of a frame synchronization bit counter, frame timing, and timing of a UW detection window for a DSRC communication circuit and DSRC communication method according to Embodiment 1 of the present invention.

Received data in DSRC communication is formed with a bit sequence of PR (preamble) and UW (unique word), a received data body, a bit sequence of CRC data and guard time. Communication frame 103 is formed with receiving slot 100 which is the head of a frame, and receiving slots 101 and 102 which is other than the head of the frame. Further, 104 is a frame switching timing which is the cut-off for a frame, and 105 is a UW detection window.

In the following, the operation of the DSRC communication circuit and DSRC communication method having the above-described configuration will be described.

In the DSRC communication standard, received data for receiving slot 100 which is the head of the frame and receiving slot 101 which is other than the head of the frame may perform reception processing such as simple privacy scrambling and data scrambling, CRC operation or error correction operation on a bit sequence after the UW, to confirm consistency of the received data or perform error correction. Further, it is necessary to take in required data out of the received data into the receiving buffer. As a result, for all receiving slots, it is necessary to detect UW bit sequences from the received data, know the position and timing of currently received data, and generate the reception processing timing for carrying out simple privacy scrambling and data scrambling at the reception processing circuit, and CRC operations and error correction, and a data storage timing for taking in data subjected to the reception processing into the receiving buffer.

Further, when this UW detection is carried out, it is necessary to reduce the probability that the same bit sequence as UW exists in the received data by accident, erroneous UW detection is carried out, and reception errors or CRC errors occur. Therefore, when the UW detection is carried out, UW detection window timing signal 105 (hereinafter referred to as UW detection window 105) is generated, and the UW detection operation is carried out only at this timing.

In the DSRC communication standard, the timing of the slots within the frame is defined as a fixed timing. However, depending on the environment where the DSRC communication is carried out, shifts between the timing of frames and timing of receiving slots may occur due to the influence of fading, or the like. The timing of the frames bears no relation to shifts in the timing of the slots, and frame switching timing 104 exists at a different timing from the cut-off of the slots. For example, even if slots lead by time shift T1 and time shift T2 with respect to the frame timing as a result of shifts in the frame timing and slot timing, frame switching timing 104 is not influenced by the shifts, and a frame is switched with delayed by time shift T3 as viewed from the slot.

Therefore, in this embodiment, the UW detection timing at receiving slot 100 which is the head of the frame is taken as synchronization timing 106, and by loading and counting up the value of the frame synchronization bit counter within the receiving circuit at frame synchronization timing 106, the frame timing is maintained.

First, in receiving slot 100 which is the head of the frame, UW detection is carried out during the timing of UW detection window 105, the frame synchronization bit counter is frame-synchronized, and the frame timing is maintained. Transmission and reception is carried out using each slot in the frame, and the frame counter continues counting up with the frame timing maintained. For example, during this time, regarding the frame timing and slot timing, it is assumed that the slot timing leads by just time shift T1 and time shift T2 for each slot. Received data of the subsequent frame is transmitted irrelevantly to the shifts in timings between the frames and the slots in the frame, and therefore a frame switching timing is delayed by just shift time T3, which is the total of time shift T1 and time shift T2 with respect to the slot timing, and data reception of the receiving slots of the head of the frame is carried out. The frame synchronization bit counter is not influenced by time shifts T1, T2 and T3, so that, even if the frame is switched to the next frame, it is possible to maintain the frame timing of the frame. By a method of generating a timing for a UW detection window in the receiving slot of the head of the subsequent frame using the frame timing of this frame, it is possible to generate a UW detection window timing of a receiving slot of the head of the subsequent frame without being influenced by shifts in the frame timing and slot timing, and reduce the frequency of UW detection errors which occur as a result of the shifts in the timing of the UW detection window in the receiving slot of the head of the frame due to the influence of accumulation of shifts in slot timing with respect to the frame timing as in the related art.

As described above, according to Embodiment 1, by using the UW detection timing of the receiving slot of the head of the frame as frame synchronization timing 106, and using a UW detection signal as an enable signal for loading a value of the frame synchronization bit counter, the frame timing is maintained in the frame synchronization bit counter, and a UW detection window of the receiving slot of the head of the frame is generated using this frame timing as a reference, so that even when the relationship between the frame timing and slot timing is changed at a timing of switching frames, it is possible to generate a UW detection window of the receiving slot of the head of the frame using the frame timing as a reference, and reduce the frequency of occurrence of UW detection errors.

Namely, regarding data reception of the related art, a single bit counter is used, and the slots are synchronized in the bit counter using the UW detection timing for all receiving slots, and the timing of the UW detection window for the subsequent receiving slot is generated from the count value of the bit counter after slot synchronization. When the slot timing is shifted with respect to the frame timing, the UW detection timing is also shifted with respect to the frame timing. Therefore, shifts in the frame timing and slot timing in the previous slot are reflected to the timing of the UW detection window of the subsequent receiving slot. When the data communication for one frame is finished, and the data reception is carried out using the head slot of the subsequent frame, there is a problem that, although the relationship of the shifts in the frame timing and the slot timing is changed as a result of switching of the frame, the UW detection window where the shifts in the frame timing and slot timing in the previous frame are reflected is generated, timings of received data and UW detection window do not match, and, as a result, UW detection errors occur. On the other hand, in this embodiment, by using the frame timing in combination with the slot timing, it is possible to generate a UW detection window which has small shifts with respect to the frame timing of the previous frame and which is not influenced by accumulation of shifts in the slot timing with respect to the frame timing for the receiving slot of the head of the frame, and generate a UW detection window which has small shifts with respect to the slot timing of the receiving slot and which is not influenced by accumulation of the shifts in the slot timing with respect to the frame timing for the receiving slot which is other than the head of the frame. It is therefore possible to suppress shifts in the frame timing and slot timing, and the shifts between the received data and the UW detection window due to the accumulation of the shifts in the frame timing and slot timing for all receiving slots. With this communication method, it is possible to provide improvement for the problem that, although the relationship of shifts in the frame timing and slot timing is changed in the receiving slot of the head of the frame, the UW detection window where the shifts in the frame timing and slot timing in the previous frame are reflected is generated, the timings of the received data and UW detection window do not match, and as a result, UW detection errors occur.

### Embodiment 2

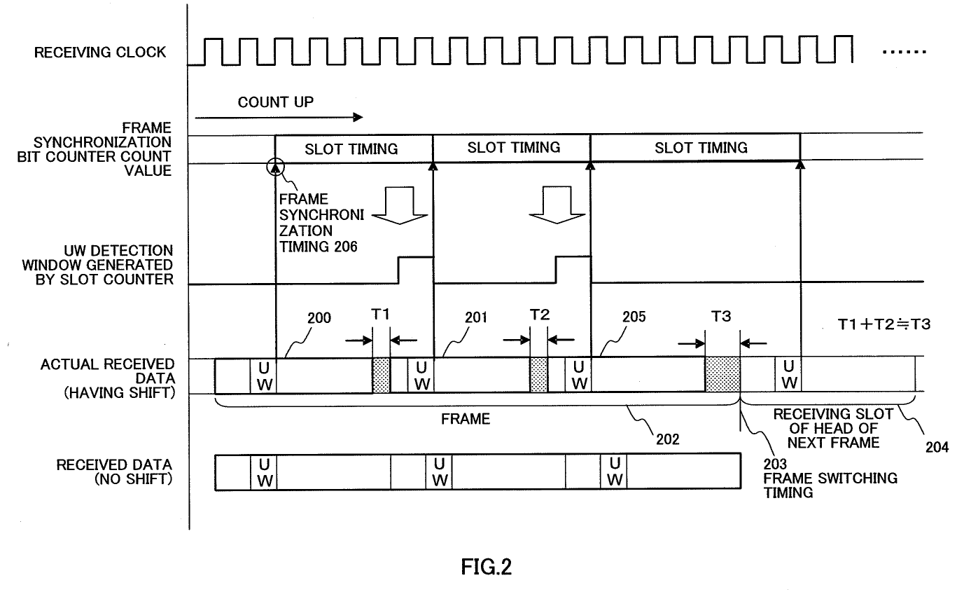

FIG. 2 is a timing diagram showing a relationship between received data and its shifts, slot synchronization timing of a slot synchronization bit counter, slot timing, and timing of a UW detection window for a DSRC communication circuit and DSRC communication method according to Embodiment 2 of the present invention.

It is necessary to perform reception processing such as simple privacy scrambling and data scrambling on the bit sequence after UW, CRC operation, and error correction operation on the received data, and store necessary data out of the received data in a receiving buffer. Therefore, at all receiving slots, it is necessary to detect UW from bit sequences for the received data, know the position and timing of the currently receiving data, and generate reception processing timing at the reception processing circuit and timing for storing the necessary data in the receiving buffer. However, the timing of slots within a frame is defined in the DSRC communication standard, but there are also cases where shifts occur in timing depending on the communication environment. The timing of the frames bears no relation to the timing of the slots, and frame switching timing 203 therefore exists at a different timing from the slot switching timing within a frame. For example, even if slots lead by time shift T1 and time shift T2 with respect to the frame timing as a result of shifts in the frame timing and slot timing, frame switching timing 203 is not influenced by the shifts, and a frame is switched with delayed by just time shift T3 as viewed from the slot.

Therefore, in this embodiment, a configuration is adopted where the UW detection timing for all receiving slots is taken as slot synchronization timing 206, and the slot timing is maintained by loading and counting up values for the slot synchronization bit counter within the receiving circuit.

First, at receiving slot 200 of the head of the frame, a UW detection window is generated using the frame timing with respect to the received data as a reference, and UW detection is carried out during the timing for this UW detection window. A UW detection signal is generated from a UW detection section upon UW detection, and this UW detection signal is taken as a load enable signal for a count value of the slot synchronization bit counter. In this way, the slot synchronization bit counter carries out slot synchronization by loading count values at the UW detection timing, and slot synchronization timing 206 is maintained by counting up. In this way, the timing for reception processing such as descrambling of the simple privacy scrambling and data scrambling on the received data of the slots subjected to slot synchronization, and CRC operation, is generated, and the timing of the UW detection window of the receiving slots other than the head of the subsequent frame is generated.

Regarding the reception processing timing, it is possible to generate the reception processing timing at an accurate timing with respect to the received data using slot synchronization timing 206 at the UW-detected slot as a reference. For example, the position of UW within the received data can be accurately known from slot synchronization timing 206 of receiving slot 200 of the head of the frame, so that it is possible to generate the reception processing timing accurately with respect to bit sequences after the UW. Further, regarding receiving slots 201 and 205 which are other than the head of the frame, the position of the UW within the received data can also be accurately known from slot synchronization timing 206, so that it is possible to generate the reception processing timing accurately with respect to bit sequences after the UW. Moreover, regarding timing generation for UW detection windows of receiving slots 201 and 205 which are other than the head of the frame, it is possible to generate a UW detection window timing which is not influenced by the accumulation of shifts in timing of slots within a frame by carrying out timing generation for UW detection windows of the subsequent slot of the slot subjected to UW detection/slot synchronization using slot synchronization timing 206. For example, considering the case of carrying out timing generation for a UW detection window of receiving slot 201 which is other than the head of the frame and is the next receiving slot, from the slot timing of receiving slot 200 of the head of the frame, time shift T1 exists between the two receiving slots. In this case, it is possible to absorb the influence of time shift T1 and carry out UW detection by providing margin and broadening the width of the UW detection window taking into consideration just time shift T1. In this way, by carrying out UW detection and slot synchronization at receiving slot 201 which is other than the head of the frame, the slot timing leads by time shift T1 with respect to the frame timing.

Next, considering the case of carrying out timing generation for a UW detection window of receiving slot 205 which is other than the head of the frame and is the next receiving slot, from the slot timing of receiving slot 201 which is other than the head of the frame, time shift T2 exists between the two receiving slots. In this case, it is possible to absorb the influence of time shift T1 and carry out UW detection by providing margin and broadening the width of the UW detection window taking into consideration just time shift T2. In this way, by carrying out UW detection and slot synchronization at receiving slot 205 which is other than the head of the frame, the slot timing leads by time shift T2 with respect to the frame timing, and shifts in the slot timing with respect to the frame timing become a total of T1+T2. Next, considering the case of carrying out timing generation for a UW detection window of receiving slot 204 which is the head of the next frame and is the next receiving slot, from slot synchronization timing 206 of receiving slot 205 which is other than the head of the frame, time shift T3 (≈T1+T2) exists between the two receiving slots. In this case, it is necessary to consider time shift T3—the accumulation of shifts of slots with respect to the frame timing—and provide margin and broaden the width of the UW detection window. It is necessary to consider the accumulation of shifts of a large number of slots depending on the slot configuration within a frame. Further, by broadening the UW detection window, the possibility of error detection for bit sequences which are the same as UW within the received data and erroneous synchronization of the bit counter increases. As a result, this invites the occurrence of reception errors and is not desirable. Therefore, by generating a UW detection window timing of the receiving slot which is other than the head of the next frame from the frame timing, it is possible to keep the margin for the UW detection window to a minimum without taking into consideration accumulation of shifts in slot timing with respect to the frame timing.

As described above, according to Embodiment 2, slot timing is maintained at a slot synchronization bit counter by taking the UW detection timing of all receiving slots in DSRC communication as slot synchronization timing 206, and taking the UW detection signal as an enable signal for loading values of the slot synchronization bit counter. The UW detection timing of the receiving slot which is other than the head of the frame is generated using this slot timing as a reference. As a result, by generating UW detection windows using a slot timing of the receiving slot other than the head of the frame as a reference, it is possible to generate UW detection windows which are subjected to little influence of the accumulation of shifts in the frame timing and slot timing, and reduce the frequency of occurrence of UW detection errors.

### Embodiment 3

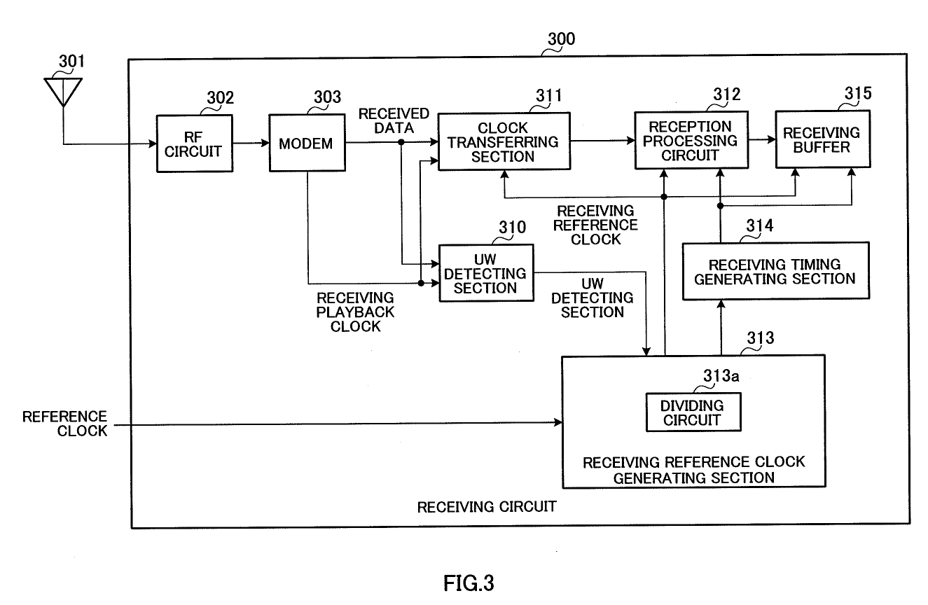

FIG. 3 is a block diagram showing a configuration of receiving circuit of a DSRC communication circuit and a communication method according to Embodiment 3 of the present invention, and shows the relationship between a UW detection section, clock transferring section, reception processing circuit and receiving reference clock generating section.

In FIG. 3, DSRC receiving circuit 300 is configured with antenna 301, RF circuit 302, modem 303, UW detecting section 310, clock transferring section 311, reception processing circuit 312, receiving reference clock generating section 313 that has dividing circuit 313a, receiving timing generating section 314 and receiving buffer 315.

UW detecting section 310 determines a unique word bit sequence through comparison with a bit sequence pattern of the unique word set in advance and generates a unique word detection signal.

Clock transferring section 311 temporally stores the received data in synchronization with a demodulated receiving playback clock, reads out the stored received data in synchronization with a receiving reference clock generated by receiving reference clock generating section 313, and transfers a clock from the receiving playback clock to the receiving reference clock.

Receiving reference clock generating section 313 generates a receiving reference clock which is different from the demodulated receiving playback clock.

In the following, the operation of a DSRC communication circuit and DSRC communication method having the above-described configuration will be described.

In data reception in DSRC communication, first, received data and a receiving clock are demodulated. In FIG. 3, the received data and receiving clock are demodulated at modem 303, and the demodulated clock is supplied to UW detecting section 310 and clock transferring section 311 as a receiving playback clock.

At UW detecting section 310, received data inputted from the modem in synchronization with the receiving playback clock is stored in receiving circuit 300, and comparison and determination are carried out with a UW bit sequence pattern set in the circuit in advance. As a result of comparison, when the stored received data and the UW bit sequence pattern set in advance match, a UW bit sequence is determined, and a UW detection signal is generated. Receiving reference clock generating section 313 operates using a different reference clock from the receiving playback clock, and the reference clock at this time is the same as the receiving playback clock, or at high frequency that can generate the same frequency clock as the receiving playback clock by frequency dividing using dividing circuit 313a.

When a UW detection signal is inputted from UW detecting section 310 to receiving reference clock generating section 313, the UW detection signal is taken as an enable signal, receiving reference clock generation is started at dividing circuit 313a within receiving reference clock generating section 313, the receiving reference clock is supplied to clock transferring section 311, reception processing circuit 312, receiving timing generating section 314 and receiving buffer 315.

Clock transferring section 311 stores the received data in receiving circuit 300 in synchronization with the receiving playback clock generated at modem 303, reads out the stored received data in synchronization with a receiving reference clock generated by receiving reference clock generating section 313, and transfers a clock from the receiving playback clock to the receiving reference clock. Received data after clock transferring is inputted to reception processing circuit 312, reception processing such as descrambling of the simple privacy scrambling and the data scrambling, CRC operation, and error correction is carried out at a reception processing timing generated by receiving timing generating section 314 in synchronization with the receiving reference clock, and stored in receiving buffer 315 at a data storing timing generated by receiving timing generating section 314.

In order to support data reception of one or a plurality of modulation schemes to support the T75 standard, it is necessary to extend the function of the receiving circuit of only one system which operates at the receiving playback clock of the related art. According to Embodiment 3, UW detecting section 310 that operates using a receiving playback clock and clock transferring section 311 are provided for each modulation scheme of a receiving target, and the reception processing section which can be shared by the modulation schemes is configured with one system that operates at a receiving reference clock. With this configuration, by generating a receiving reference clock within the receiving circuit, transferring the received data from the receiving playback clock to the receiving reference clock, and carrying out reception processing using the receiving reference clock, it is possible to easily share the reception processing circuit, and reduce the circuit dimension and power consumption by sharing the circuit. Namely, at the shared reception processing section, it is necessary to switch the receiving reference clock used by the modulation scheme of data subjected to reception processing. However, at receiving reference clock generating section 313, it is possible to carry out reception processing in complete synchronization by generating a timing of the receiving reference clock for each modulation scheme and a clock switching timing from the same reference clock, and therefore facilitate the circuit design.

Further, by maintaining the frame timing and slot timing using the bit counter, and generating a timing for data reception using these timings, it is possible to reduce the frequency of decreasing data communication efficiency as a result of the occurrence of UW detection errors upon frame switching by carrying out processing such as data retransmission waiting and UW1 consecutive reception, and also reduce the frequency of decreasing data communication efficiency by carrying out processing such as data retransmission waiting even for receiving slots other than the head of the frame.

### Embodiment 4

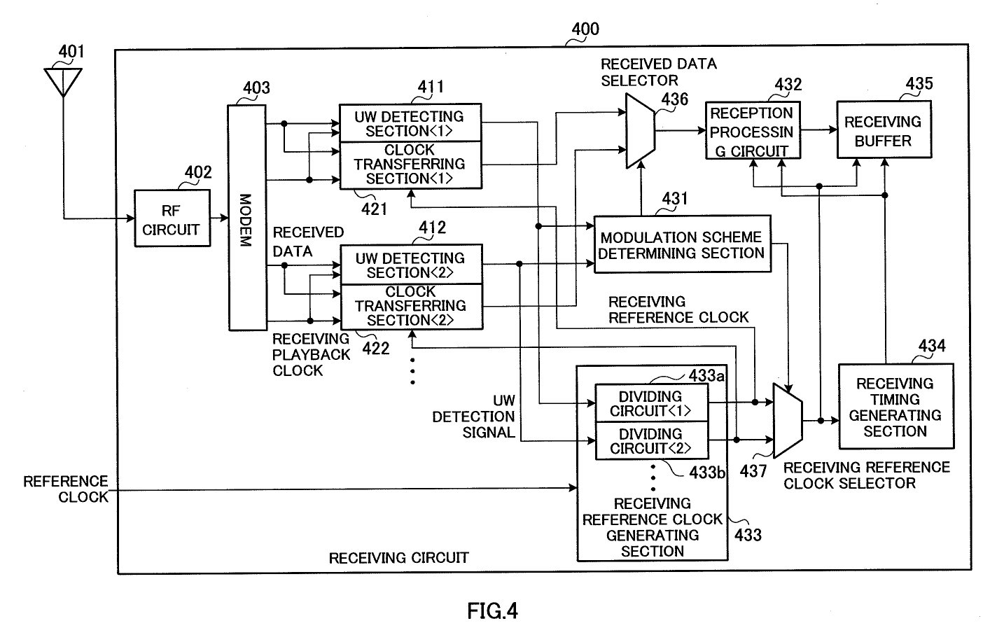

FIG. 4 is a block diagram showing a configuration of a receiving circuit of a DSRC communication circuit and a DSRC communication method according to Embodiment 4 of the present invention, and shows the relationship between a UW detecting section, clock transferring section, reception processing circuit, receiving reference clock generating section and reception processing circuit.

In FIG. 4, DSRC receiving circuit 400 is configured having antenna 401, RF circuit 402, modem 403, UW detecting section 411 (UW detecting section <1>), UW detecting section 412 (UW detecting section <2>), clock transferring section 421 (clock transferring section <1>) clock transferring section 422 (clock transferring section <2>), modulation scheme determining section 431, reception processing circuit 432, receiving reference clock generating section 433 that has dividing circuits 433a and 433b, receiving timing generating section 434, receiving buffer 435, receiving data selector 436 and receiving reference clock selector 437.

In FIG. 4, two groups of UW detecting section 411 (UW detecting section <1>) and clock transferring section 421 (clock transferring section <1>), and UW detecting section 412 (UW detecting section <2>) and clock transferring section 422 (clock transferring section <2>) are shown, but it is also possible to provide two or more UW detecting sections and clock transferring sections to support a plurality of modulation schemes.

In the following, the operation of a DSRC communication circuit and DSRC communication method having the above-described configuration will be described.

In data reception in DSRC communication, with the T55 standard, the modulation scheme is only ASK, but with the T75 standard which is a superior standard, not just ASK but also QPSK (Quaternary PSK) is used, and the frame is configured with not only slots for a single modulation scheme of ASK or QPSK, but there are also frames that combine ASK and QSPK, and it is necessary to support these communication. There are cases where the first received data is ASK or QPSK depending on the roadside equipment carrying out DSRC communication, and it is necessary to support either data reception.

In communication frames where the modulation scheme is only ASK, only a receiving circuit for one system of ASK is necessary for reception, but in order to also support QPSK, a receiving circuit for another one system is necessary. However, there is also a portion where the reception processing is carried out at the completely same reception processing circuit between the data reception of ASK and QPSK. In this embodiment, receiving circuits of two systems of ASK and QPSK are not simply provided, but portions capable of being shared are shared, and reduction in circuit dimension and power consumption is achieved.

First, regarding demodulation of received data, in order to support data reception of either modulation scheme, as shown in FIG. 4, received data and a receiving clock are demodulated individually for each modulation scheme at modem 403, and the demodulated clock is supplied to UW detecting section 411 (UW detecting section <1>) and clock transferring section 421 (clock transferring section <1>), and UW detecting section 412 (UW detecting section <2>) and clock transferring section 422 (clock transferring section <2>) as a receiving playback clock.

At UW detecting section 411 (UW detecting section <1>) and UW detecting section 412 (UW detecting section <2>), received data inputted from the modem in synchronization with the receiving playback clock is stored in receiving circuit 400, and comparison and determination are carried out with a UW bit sequence pattern set in the circuit in advance. As a result of comparison, when the stored received data and the UW bit sequence pattern set in advance match, it is determined as a UW bit sequence, and a UW detection signal is generated. Receiving reference clock generating section 433 operates using a different reference clock from the receiving playback clock, and, at this time, the reference clock adopts a frequency that is a minimum common multiple of the two receiving playback clock frequencies so as to enable generation of a clock of a frequency which is the same as the respective receiving playback clocks through dividing.

When a UW detection signal is inputted from UW detecting section 411 (UW detecting section <1>) or UW detecting section 412 (UW detecting section <2>) to receiving reference clock generating section 433, the receiving reference clocks are generated at dividing circuits 433a and 433b within receiving reference clock generating section 433 using the UW detection signal as an enable signal, and the clocks are supplied to clock transferring section 421 (clock transferring section <1>) or clock transferring section 422 (clock transferring section <2>).

At clock transferring section 421 (clock transferring section <1>) and clock transferring section 422 (clock transferring section <2>), the received data is stored in receiving circuit 400 in synchronization with the receiving playback clock generated at modem 403, the stored data is read out in synchronization with the receiving reference clock generated at receiving reference clock generating section 433, and a clock is transferred from the receiving playback clock to the receiving reference clock.

At modulation scheme determining section 431, received data selector 436 and receiving reference clock selector 437 are switched so as to supply the received data to reception processing circuit 432 and supply the receiving reference clock to reception processing circuit 432 and receiving timing generating section 434, but it is also possible to adopt a configuration capable of selecting whether the selector is switched according to the UW detection signal at UW detection section 411 (UW detecting section <1>) and UW detection section 412 (UW detecting section <2>) or mode setting is carried out at receiving circuit 400 to control switching of the selector.

Received data and the receiving reference clock of the modulation scheme selected by receiving data selector 436 and receiving reference clock selector 437 are inputted to reception processing circuit 432, reception processing such as descrambling of simple privacy scrambling and data scrambling, CRC operation, and error correction is carried out at a reception processing timing generated at receiving timing generating section 434 in synchronization with the receiving reference clock, and stored in receiving buffer 435 at a data storing timing generated by receiving timing generating section 434.

As described above, according to Embodiment 4 of the present invention, a configuration is adopted where one reception processing section, selectors 436 and 437 that select data of a modulation scheme of reception processing and a receiving reference clock, receiving reference clock generating section 433 that generates a receiving reference clock used at the reception processing section, UW detecting sections 411 and 412 that operate using a receiving playback clock for each modulation scheme of a receiving target, and clock transferring sections 421 and 422 are provided. The reception processing section that can be shared by the modulation schemes is configured with only one system that operates using the receiving reference clock. Further, modulation scheme determining section 431 capable of selecting by UW detection or mode setting of the receiving circuit and receiving reference clock generating section 433 that selects and generates a clock for making the reception processing section operate by UW detection are provided. With this configuration, by supporting data reception of one or a plurality of modulation schemes with a simple circuit configuration, generating a receiving reference clock within the receiving circuit, transferring the received data from the receiving playback clock to the receiving reference clock, and carrying out reception processing using the receiving reference clock, it is possible to easily share the reception processing circuit, and reduce the circuit dimension and power consumption by sharing the circuit. Namely, in reception processing of received data of different modulation schemes, by sharing the sharable reception processing section, it is possible to implement a receiving circuit which supports a plurality of modulation schemes with a simpler configuration than for the case of the configuration having receiving circuits of different systems for each modulation scheme, and reduce circuit dimension and power consumption.

Further, for the shared reception processing section, it is necessary to switch the receiving reference clock used by the modulation scheme of data subjected to reception processing, but, at the receiving reference clock generating section, it is possible to carry out reception processing in complete synchronization by generating a receiving reference clock of each modulation scheme and a timing of clock switching from the same reference clock, and facilitate the circuit design. By adopting such a data receiving method and circuit configuration, it is possible to implement data reception processing of one or a plurality of modulation schemes such as ASK and QPSK, or slots where ASK and QPSK coexist, using a simple circuit with a small dimension and low power consumption.

The above description is an example of preferred embodiments of the present invention, and by no means limits the scope of the present invention.

Further, the term of “DSRC communication circuit and DSRC communication method” is used in this embodiment, but this is merely for simplicity of description, and this may also be referred to as “narrow band communication apparatus and communication method”, or the like.

Moreover, each circuit section configuring the above-described DSRC communication circuit, such as the type, number, and connection method, and further, the type of specific function sections is by no means limited to the above-described embodiments.

As described above, according to the present invention, it is possible to prevent troubles of causing UW detection errors as a result of shifts occurring in the timings of the received data and UW detection window upon frame switching of data reception.

Further, it is possible to support data reception of one or a plurality of modulation schemes with a circuit configuration taking into consideration simplicity, small dimension and low power consumption.

Therefore, the DSRC communication circuit and DSRC communication method according to the present invention can be applied not only to the T55 standard which is a standard for DSRC communication used in current ETC services, but also to the T75 standard including a specification where the modulation scheme changes for each slot in data transmission and reception within one frame. Further, the present invention can be applied also in cases where the T75 standard is extended so as to add the specification for a QPSK-VP (Varied Phase) modulation scheme. Moreover, even when DSRC communication is carried out across a plurality of roadside equipments, if data communication is carried out with the plurality of roadside equipments synchronized, the present invention can be similarly applied. Therefore, it is expected that the present invention can be effectively used even when various services that apply DSRC communication are started in the future.

What is claimed is:

1. A DSRC communication circuit comprising:
a frame timing generating section that receives a unique word detection window timing signal of a receiving slot of the head of a frame, synchronizes frames, and counts up a first synchronization bit counter to generate a frame timing; and
a unique word detection window timing generating section that generates a timing signal for a unique word detection window of a receiving slot of the head of the next frame using the generated frame timing as a reference.

2. A DSRC communication circuit comprising:
a slot timing generating section that receives unique word detection window timing signals for all receiving slots, takes the unique word detection window timings as slot timings, and counts up a second synchronization bit counter to generate a slot timing; and
a unique word detection window timing generating section that generates a timing signal for a unique word detection window of a receiving slot which is other than the head of a frame using the generated slot timing as a reference.

3. The DSRC communication circuit according to claim 1, wherein the unique word detection window timing generating section generates the unique word detection window timing signal for detecting unique words at a plurality of slots configuring the frame according to the unique word detection window.

4. A DSRC communication circuit comprising:
a unique word detection section that determines a unique word bit sequence through comparison with a bit sequence pattern of a unique word set in advance and generates a unique word detection signal; and
a receiving reference clock generating section that generates a receiving reference clock different from a demodulated receiving playback clock, wherein:
the unique word detection section carries out unique word detection using the receiving playback clock; and
the receiving reference clock generating section generates the receiving reference clock so as to match a timing of the unique word detection.

5. The DSRC communication circuit according to claim 4, further comprising a clock transferring section that temporarily stores received data in synchronization with the demodulated receiving playback clock, reads out the stored received data in synchronization with the receiving reference clock generated by the receiving reference clock generating section, and transfers a clock from the receiving playback clock to the receiving reference clock.

6. The DSRC communication circuit according to claim 5, wherein the UW detection section and/or the clock transferring section are provided for each one or plurality of modulation schemes.

7. The DSRC communication circuit according to claim 5, further comprising a selection section that selects whether switching of data of the modulation scheme for carrying out reception processing and receiving reference clock is set by the UW detection section or is set through mode setting.

8. A DSRC communication method comprising the steps of:
receiving a unique word detection window timing signal of a receiving slot of the head of a frame, synchronizing frames, and counting up a first synchronization bit counter to generate a frame timing; and
generating a timing signal for a unique word detection window of a receiving slot of the head of the next frame using the generated frame timing as a reference.

9. A DSRC communication method comprising the steps of:
receiving unique word detection window timing signals for all receiving slots, taking the unique word detection window timings as slot timings, and counting up a second synchronization bit counter to generate a slot timing; and
generating a timing signal for a unique word detection window of a receiving slot which is other than the head of the frame using the generated slot timing as a reference.

10. A DSRC communication method comprising the steps of:
determining a unique word bit sequence through comparison with a bit sequence pattern of a unique word set in advance and generating a unique word detection signal according to a receiving playback clock; and
generating a receiving reference clock signal different from a demodulated receiving playback clock so as to match a timing of the unique word detection.
